(19) United States
(12) Patent Application Publication
(10) Pub. No.: US 2022/0132467 A1
(43) Pub. Date: Apr. 28, 2022

(54) METHOD AND SYSTEM FOR HANDLING SERVICE NOTIFICATION AND CONFIGURATION FOR MBS IN 5G COMMUNICATION NETWORK

(71) Applicant: Samsung Electronics Co., Ltd., Suwon-si (KR)

(72) Inventors: Vinay Kumar SHRIVASTAVA, Bangalore (IN); Fasil Abdul LATHEEF, Bangalore (IN); Himke VAN DER VELDE, Staines (GB); Sangkyu BAEK, Suwon-si (KR)

(21) Appl. No.: 17/452,034

(22) Filed: Oct. 22, 2021

(30) Foreign Application Priority Data
Oct. 22, 2020 (IN) 202041046160
Oct. 1, 2021 (IN) 2020 41046160

(51) Int. Cl. H04W 72/00; H04W 4/06; H04W 48/16; H04W 76/10; H04W 68/00

(52) U.S. Cl. CPC H04W 72/005; H04W 4/06; H04W 68/00; H04W 76/10; H04W 48/16

(57) ABSTRACT

Generation (5G) communication system for supporting higher data rates beyond a 4th-Generation (4G) system with a technology for Internet of Things (IoT). Embodiments herein achieve methods for handling a service notification and configuration for an MBS in a 5G communication network by a UE. The method includes synchronizing an MBS service list in a USD with an available list of MBS services based on an indication. Further, the method includes determining at least one of at least one available MBS service or at least one unavailable MBS service in the USD. Further, the method includes performing at least one of: identifying at least one interested MBS service from the at least one unavailable MBS service and sending an interest indication message to a network entity, wherein the interest indication message comprises information associated with at least one interested MBS service or identifying at least one interested MBS service from the at least one available MBS service and triggering a service join procedure.

### CROSS REFERENCE TO RELATED APPLICATIONS

This application is based on and claims priority under 35 U.S.C. § 119(a) to Indian Patent Application No. 202041046160 (PS) filed on Oct. 22, 2020, and Indian Patent Application No. 202041046160 (CS) filed on Oct. 1, 2021, in the Indian Patent Office, the disclosures of which are herein incorporated by reference in their entirety.

### BACKGROUND

### 1. Field

Embodiments disclosed herein relate to a Fifth Generation (5G) communication network, and more particularly to methods and systems for handling a service notification and configuration for a multicast broadcast service (MBS) in the 5G communication network.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access(NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

5G New Radio (NR) is targeting support for Multicast and Broadcast services in 3GPP release 17 version of specification being prepared by 3^{rd} Generation Partnership Project (3GPP). In legacy MBMS (Multimedia Broadcast Multicast Services) were supported in a LTE (Long Term Evolution) 4G wireless systems. However, the architecture and the requirements of 5G Multicast Broadcast Services (MBS) could be very different and there is an effort in the direction of designing the architecture for the network as well as the User Equipment (UE) is in progress.

Specifically, multicast services refer to services being transmitted and availed by a set of UEs registered to a group e.g., MCPTT (Mission Critical Push-To-Talk) service. Broadcast services refer to services being transmitted and available to all the UEs in a specific coverage area where broadcast is performed and typically, UE may not need to be registered e.g., Television services. Therefore, effectively, both multicast and broadcast services are PTM (Point-To-MultiPoint) services as there is one transmitter and multiple recipient of contents. It is also possible to provide multicast and broadcast services in a PTP (Point-to-Point) manner, wherein there are multiple PTP connections to provide the same MBS services to a number of individual recipients. Apart from Multicast and Broadcast services, there are another category of services termed as Unicast services which is meant for one recipient only for this is one to one dedicated connection between transmitter and receiver.

It is possible to have PTM bearer, PTP bearer or a combination of PTM and PTP bearer to carry the same MBS service. Combination of PTM and PTP bearer may provide a lot of features with respect to increase reliability of reception of MBS service packets, efficient switching between these two modes of reception when needed e.g., because of mobility, network loading conditions or based on the user request density for the reception of the MBS service and accordingly network may decide the delivery modes and/or switching across. A bearer configuration which has possibly both legs of PTM and PTP is termed as MBS split bearer.

The principal object of the embodiments herein is to disclose methods and systems for providing notifications and configurations for Multicast/Broadcast services in a 5G network.

The method can be used to enable a reliable delivery of MBS services by introducing split radio bearer (i.e., PTP+PTM). The method can be used for group notifications for UEs in an idle/inactive state about MBS services which is more efficient when compared to legacy methods (unicast paging).

### SUMMARY

Accordingly, the embodiments herein disclose methods for handling a service notification and configuration for an MBS in a 5G communication network. The method includes receiving, by a UE, an MBS information through at least one of at least one SIB or a MCCH. The MBS information includes a list of MBS services. Further, the method includes indicating, by the UE, an available list of MBS services to a service layer of the UE from a lower layer of the UE based on the received MBS information. Further, the method includes synchronizing, by the UE, an MBS service list in a user service description (USD) with the available list of MBS services based on the indication. Further, the method includes determining, by the UE, at least one of at least one available MBS service or at least one unavailable MBS service in the USD. Further, the method includes performing, by the UE, at least one of: identifying at least one interested MBS service from the at least one unavailable MBS service and sending an interest indication message to a network entity, wherein the interest indication message comprises information associated with at least one interested MBS service or identifying at least one interested MBS service from the at least one available MBS service and triggering a service join procedure.

In an embodiment, each MBS service from the list of MBS services comprises at least one field, wherein the at least one field comprises a TMGI of the MBS service, a session identifier (MBS session ID), a service type, a discontinuous reception (DRX) configuration for the MBS service, MBS traffic channel (MTCH) configuration for the MBS service, neighbour cell information for the MBS service where for at least one neighbour cell same MBS service (as on serving cell) is one of available and not available, or a bandwidth part (BWP) over which MBS service, is being delivered.

In an embodiment, the MCCH carries complete point-to-multiPoint (PTM) configuration information and neighbor cell information for PTM service availability in at least one neighbor cell to support a cell reselection and/or getting connected to avail service reception through unicast.

In an embodiment, the neighbor cell information comprises a bitmap with a first value indicating at least one PTM service availability in the at least one neighbor cell and a bitmap with a second value indicating at least one PTM service unavailability in the at least one neighbor cell, where in the at least one PTM service is provided in the serving cell.

In an embodiment, the method comprises transmitting, to a network entity, message indicating UE capability, wherein a radio network temporary identifier (RNTI) supported for the UE is determined based on the UE capability.

In an embodiment, the neighbor cell information is used to select a cell for an IDLE mode mobility or an INACTIVE mode mobility where the at least one PTM service, that the UE is receiving or interested to receive, is indicated as available on the neighbor cell as the source cell.

In an embodiment, the neighbor cell information is used to establish a radio resource control (RRC) connection and avail MBS service through a unicast mode, upon handover to the neighbor cell where the at least one PTM service, that the UE is receiving or interested to receive, is indicated as unavailable on the neighbor cell as the source cell.

In an embodiment, the cell reselection is performed with prioritizing at least one frequency over which the MBS service is currently being provided on a source cell or on a frequency for a neighbor where the MBS service is available.

In an embodiment, the at least one SIB is used for providing at least one of a MCCH configuration, a notification configuration or a control information, wherein the at least one SIB is transmitted by at least one of a periodical SIB transmission, a SIB transmission only when there is change in the at least one SIB, or an on-demand SIB acquisition when the UE does not have stored SIB information and no page or a physical downlink control channel (PDCCH) change is indicated, wherein the at least one SIB is provided on a cell supporting MBS.

In an embodiment, the at least one SIB is used for providing mapping of at least one of a MBS services, frequencies for reception and service area identities (SAIs), wherein the at least one SIB is transmitted by at least one of a periodical SIB transmission, a SIB transmission only when there is change in the at least one SIB, or an on-demand SIB acquisition when the UE does not have stored SIB information, wherein the at least one SIB is provided on a cell one of supporting MBS and not supporting MBS.

In an embodiment, the at least one SIB is used for also providing information for the frequencies which are supporting MBS and/or supporting multicast services and/or supporting specific service area identities (SAIs) pertaining to multicast services.

In an embodiment, the method includes sending, by the UE, one of a radio resource control (RRC) resume request and a RRC connection request with at least one indication to the network entity. The UE is in one of an RRC_INACTIVE state and an RRC_IDLE state. The at least one indication comprises a low priority MBS cause, a high priority MBS cause, a critical MBS cause, an MBS cause and a mt-access cause. Further, the method includes receiving, by the UE, a response to one of the RRC resume request and the RRC connection request from the network entity based on the at least one indication.

Accordingly, the embodiments herein disclose methods for handling a service notification and configuration for an MBS in a 5G communication network. The method includes receiving, by a UE, a core network (CN) paging message from a network entity. The CN paging message includes an MBS paging list of a temporary mobile group identities (TMGIs) for session activation. The UE is in an RRC_IDLE state. Further, the method includes determining, by the UE, an activation for at least one non-activated session pertaining to the UE based on the CN paging message. Further, the method includes performing, by the UE, a RRC connection establishment procedure between the UE and the network entity. Further, the method includes sending, by the UE, a session join request to the network entity based on the RRC connection establishment procedure. Further, the method includes receiving, by the UE, a RRC reconfiguration message comprising an MBS service configuration from the network entity for the activated MBS service based on the session join request. Further, the method includes receiving, by the UE, an MBS data from the network entity based on the RRC reconfiguration message.

Accordingly, the embodiments herein disclose methods for handling a service notification and configuration for an MBS in a 5G communication network. The method includes receiving, by a UE, a radio access network (RAN) paging message from a network entity. The RAN paging message includes an MBS paging list of a TMGIs for session activation. The UE is in an RRC_INACTIVE state. Further, the method includes determining, by the UE, an activation for at least one non-activated session pertaining to the UE based on the RAN paging message. Further, the method includes performing, by the UE, a RRC resume procedure between the UE and the network entity. Further, the method includes receiving, by the UE, a RRC reconfiguration message comprising an MBS service configuration from the network entity for the activated MBS service. Further, the method includes receiving, by the UE, an MBS data from the network entity based on the RRC reconfiguration message.

Accordingly, the embodiments herein disclose methods for handling a service notification and configuration for an MBS in a 5G communication network. The UE is in an RRC_CONNECTED state. The method includes receiving, by a UE, a RRC reconfiguration message comprising an MBS service configuration from the network entity for the activated MBS service. Further, the method includes determining, by the UE, an activation for at least one non-activated session pertaining to the UE based on the RRC reconfiguration message. Further, the method includes receiving, by the UE, an MBS data from the network entity based on the RRC reconfiguration message.

Accordingly, the embodiments herein disclose method for handling a service notification and configuration for an MBS in a 5G communication network. The method includes sending, by a network entity, a CN paging message to a UE. The CN paging message includes an MBS paging list of a TMGIs for session activation, wherein the UE is in an RRC_IDLE state. Further, the method includes performing, by the network entity, a RRC connection establishment procedure between the UE and the network entity in response to determining an activation for at least one non-activated session pertaining to the UE based on the CN paging message. Further, the method includes receiving, by the network entity, a session join request from the UE based on the RRC connection establishment procedure. Further, the method includes sending, by the network entity, a RRC reconfiguration message comprising an MBS service configuration to the UE for the activated MBS service based on the session join request. Further, the method includes sending, by the network entity, an MBS data to the UE based on the RRC reconfiguration message.

Accordingly, the embodiments herein disclose methods for handling a service notification and configuration for an MBS in a 5G communication network. The method includes sending, by a network entity, a RAN paging message to a UE. The RAN paging message includes an MBS paging list of a TMGIs for session activation, wherein the UE is in an RRC_INACTIVE state. Further, the method includes performing, by the network entity, a RRC resume procedure between the UE and the network entity in response to determining an activation for at least one non-activated session pertaining to the UE based on the RAN paging message. Further, the method includes sending, by the network entity, a RRC reconfiguration message comprising an MBS service configuration to the UE for the activated MBS service. Further, the method includes sending, by the network entity, an MBS data to the UE based on the RRC reconfiguration message.

Accordingly, the embodiments herein disclose method for handling a service notification and configuration for an MBS in a 5G communication network. The method includes receiving, by a network entity, one of a RRC resume request and a RRC connection request with at least one indication from a UE. The UE is in one of an RRC_INACTIVE state and an RRC_IDLE state. The at least one indication comprises a low priority MBS cause, a high priority MBS cause, a mt-access cause, a critical MBS cause. Further, the method includes performing, by the network entity, when the 5G communication network is having congestion, at least one of: accepting one of the RRC resume request and the RRC connection request from the UE if the at least one indication comprises a high priority MBS cause, the mt-access cause and the critical MBS cause, or rejecting one of the RRC resume request and the RRC connection request from the UE if the at least one indication comprises a low priority MBS cause.

Accordingly, the embodiments herein disclose methods for handling a service notification and configuration for an MBS in a 5G communication network. The UE is in an RRC_CONNECTED state. Further, the method includes determining, by the UE, an activation for at least one non-activated session. The method includes sending, by a network entity, a RRC reconfiguration message comprising an MBS service configuration to the UE for the at least one activated MBS service. Further, the method includes sending, by the network entity, an MBS data to the UE based on the RRC reconfiguration message.

Accordingly, the embodiments herein disclose a UE for handling a service notification and configuration for an MBS in a 5G communication network. The UE includes an MBS service notification and configuration controller coupled with a processor and a memory. The MBS service notification and configuration controller is configured to receive an MBS information through at least one of a SIB or a MCCH. The MBS information comprises a list of MBS services. The MBS service notification and configuration controller is configured to indicate an available list of MBS services to a service layer of the UE from a lower layer of the UE based on the received MBS information. The MBS service notification and configuration controller is configured to synchronize an MBS service list in a USD with the available list of MBS services based on the indication. The MBS service notification and configuration controller is configured to determine at least one of at least one available MBS service or at least one unavailable MBS service in the USD. The MBS service notification and configuration controller is configured to perform at least one of: identify at least one interested MBS service from the at least one unavailable MBS service and send an interest indication message to a network entity, wherein the interest indication message comprises information associated with at least one interested MBS service or identify at least one interested MBS service from the at least one available MBS service and trigger a service join procedure.

Accordingly, the embodiments herein disclose a UE for handling a service notification and configuration for an MBS in a 5G communication network. The UE includes an MBS service notification and configuration controller coupled with a processor and a memory. The MBS service notification and configuration controller is configured to receive a CN paging message from a network entity. The CN paging message includes an MBS paging list of a TMGIs for session activation, wherein the UE is in an RRC_IDLE state. The MBS service notification and configuration controller is configured to determine an activation for at least one non-activated session pertaining to the UE based on the CN paging message. Further, the MBS service notification and configuration controller is configured to perform a RRC connection establishment procedure between the UE and the network entity. Further, the MBS service notification and configuration controller is configured to send a session join request to the network entity based on the RRC connection establishment procedure. Further, the MBS service notification and configuration controller is configured to receive a RRC reconfiguration message comprising an MBS service configuration from the network entity for the activated MBS service based on the session join request. Further, the MBS service notification and configuration controller is configured to receive an MBS data from the network entity based on the RRC reconfiguration message.

Accordingly, the embodiments herein disclose a UE for handling a service notification and configuration for an MBS in a 5G communication network. The UE includes an MBS service notification and configuration controller coupled with a processor and a memory. The MBS service notification and configuration controller is configured to receive a RAN paging message from a network entity. The RAN paging message includes an MBS paging list of a TMGIs for session activation, wherein the UE is in an RRC_INACTIVE state. The MBS service notification and configuration controller is configured to determine an activation for at least one non-activated session pertaining to the UE based on the RAN paging message. Further, the MBS service notification and configuration controller is configured to perform a RRC resume procedure between the UE and the network entity. Further, the MBS service notification and configuration controller is configured to receive a RRC reconfiguration message comprising an MBS service configuration from the network entity for the activated MBS service. Further, the MBS service notification and configuration controller is configured to receive an MBS data from the network entity based on the RRC reconfiguration message.

Accordingly, the embodiments herein disclose a network entity for handling a service notification and configuration for an MBS in a 5G communication network. The network entity includes an MBS service notification and configuration controller coupled with a processor and a memory. The MBS service notification and configuration controller is configured to send a CN paging message to a UE. The CN paging message includes an MBS paging list of a TMGIs for session activation, where the UE is in an RRC_IDLE state. Further, the MBS service notification and configuration controller is configured to perform a RRC connection establishment procedure between the UE and the network entity in response to determining an activation for at least one non-activated session pertaining to the UE based on the CN paging message. Further, the MBS service notification and configuration controller is configured to receive a session join request from the UE based on the RRC connection establishment procedure. Further, the MBS service notification and configuration controller is configured to send a RRC reconfiguration message comprising an MBS service configuration to the UE for the activated MBS service based on the session join request. Further, the MBS service notification and configuration controller is configured to send an MBS data to the UE based on the RRC reconfiguration message.

Accordingly, the embodiments herein disclose a network entity for handling a service notification and configuration for an MBS in a 5G communication network. The network entity includes an MBS service notification and configuration controller coupled with a processor and a memory. The MBS service notification and configuration controller is configured to send a RAN paging message to a UE. The RAN paging message includes an MBS paging list of a TMGIs for session activation, wherein the UE is in an RRC_INACTIVE state. Further, the MBS service notification and configuration controller is configured to perform a RRC resume procedure between the UE and the network entity in response to determining an activation for at least one non-activated session pertaining to the UE based on the RAN paging message. Further, the MBS service notification and configuration controller is configured to send a RRC reconfiguration message comprising an MBS service configuration to the UE for the activated MBS service. Further, the MBS service notification and configuration controller is configured to send an MBS data to the UE based on the RRC reconfiguration message.

Accordingly, the embodiments herein disclose a network entity for handling a service notification and configuration for an MBS in a 5G communication network. The network entity includes an MBS service notification and configuration controller coupled with a processor and a memory. The MBS service notification and configuration controller is configured to receive one of a RRC resume request and the RRC connection request with at least one indication from a User Equipment (UE), wherein the UE is in an RRC_INACTIVE state and an RRC_IDLE state, wherein the at least one indication comprises a low priority, a high priority, a mt-access cause and a critical MBS cause. The MBS service notification and configuration controller is configured to perform at least one of: accept one of the RRC resume request and the RRC connection request from the UE if the at least one indication comprises the high priority MBS cause, the critical MBS cause and the mt-access cause, or reject one of the RRC resume request and the RRC connection request from the UE if the at least one indication comprises the low priority MBS cause, when the network is having congestion.

Accordingly, the embodiments herein disclose a UE for handling a service notification and configuration for an MBS in a 5G communication network. The UE includes an MBS service notification and configuration controller coupled with a processor and a memory. The MBS service notification and configuration controller is configured to receive a RRC reconfiguration message comprising an MBS service configuration from a network entity for an activated MBS service, wherein the UE is in an RRC_CONNECTED state. Further, the MBS service notification and configuration controller is configured to determine an activation for at least one non-activated session pertaining to the UE based on the RRC reconfiguration message and receive an MBS data from the network entity based on the RRC reconfiguration message.

Accordingly, the embodiments herein disclose a network entity for handling a service notification and configuration for an MBS in a 5G communication network. The network entity includes an MBS service notification and configuration controller coupled with a processor and a memory. The MBS service notification and configuration controller is configured to send a RRC reconfiguration message comprising an MBS service configuration to a UE for the at least one activated MBS service, wherein the UE is in an RRC_CONNECTED state. The MBS service notification and configuration controller is configured to send an MBS data to the UE based on the RRC reconfiguration message upon determining an activation for at least one non-activated session pertaining to the UE based on the RRC reconfiguration message.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an architecture for the protocol stack for a UE implementation supporting MBS services;

FIG. 2 illustrates an overview of a 5G communication network for handling a service notification and configuration for the MBS according to embodiments as disclosed herein;

FIG. 3 illustrates various hardware components of a UE according to embodiments as disclosed herein;

FIG. 4 illustrates various hardware components of a network entity according to embodiments as disclosed herein;

FIG. 5 is a flow chart illustrating a method, implemented by the UE, for handling a service notification and configuration for the MBS in the 5G communication network based on MBS information according to embodiments as disclosed herein;

FIG. 6 is a flow chart illustrating a method, implemented by the UE, for handling the service notification and configuration for the MBS in the 5G communication network based on a CN paging message according to embodiments as disclosed herein;

FIG. 7 is a flow chart illustrating a method, implemented by the UE, for handling the service notification and configuration for the MBS in the 5G communication network based on a RAN paging message according to embodiments as disclosed herein;

FIG. 8 is a flow chart illustrating a method, implemented by the network entity, for handling the service notification and configuration for the MBS in the 5G communication network based on the CN paging message according to embodiments as disclosed herein;

FIG. 9 is a flow chart illustrating a method, implemented by the network entity, for handling the service notification and configuration for the MBS in the 5G communication network based on the RAN paging message according to embodiments as disclosed herein;

FIG. 10 is a flow chart illustrating a method, implemented by the network entity, for handling the service notification and configuration for the MBS in the 5G communication network according to embodiments as disclosed herein;

FIG. 11 is a sequence flow diagram illustrating step by step operations for handling the service notification and configuration for the MBS in the 5G communication network based on the CN paging message according to embodiments as disclosed herein;

FIG. 12 is a sequence flow diagram illustrating step by step operations for handling the service notification and configuration for the MBS in the 5G communication network based on the RAN paging message according to embodiments as disclosed herein;

FIG. 13 is a flow chart illustrating a method, implemented by the UE for handling a service notification and configuration for the MBS in the 5G communication network, when the UE is in an RRC CONNECTED state according to embodiments as disclosed herein; and

FIG. 14 is a flow chart illustrating a method, implemented by the network entity, for handling the service notification and configuration for the MBS in the 5G communication network, when the UE is in the RRC CONNECTED state according to embodiments as disclosed herein.

### DETAILED DESCRIPTION

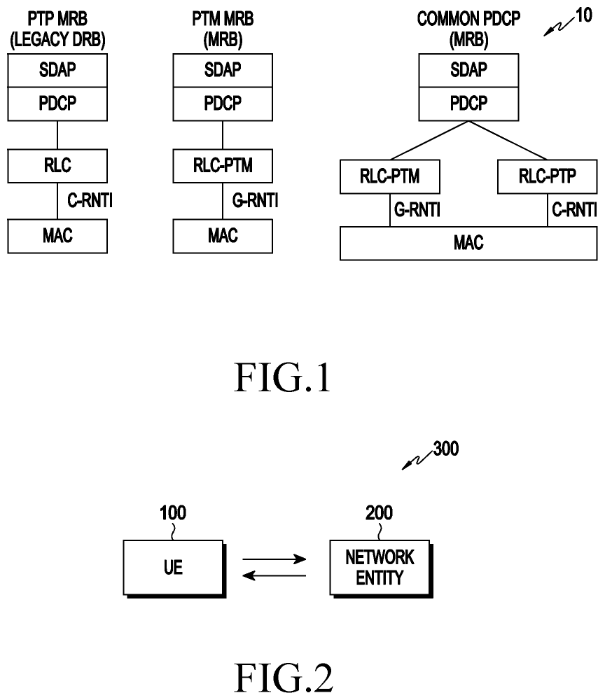

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods for handling a service notification and configuration for an MBS in a 5G communication network. The method includes receiving, by a UE, an MBS information through at least one of at least one SIB or a MCCH. The MBS information includes a list of MBS services. Further, the method includes indicating, by the UE, an available list of MBS services to a service layer of the UE from a lower layer of the UE based on the received MBS information. Further, the method includes synchronizing, by the UE, an MBS service list in a user service description (USD) with the available list of MBS services based on the indication. Further, the method includes determining, by the UE, at least one of at least one available MBS service or at least one unavailable MBS service in the USD. Further, the method includes performing, by the UE, at least one of: identifying at least one interested MBS service from the at least one unavailable MBS service and sending an interest indication message to a network entity, wherein the interest indication message comprises information associated with at least one interested MBS service or identifying at least one interested MBS service from the at least one available MBS service and triggering a service join procedure.

The method can be used to enable a reliable delivery of MBS services by introducing split radio bearer (i.e., PTP+PTM). The method can be used for group notifications for UEs in an idle/inactive state about MBS services which is more efficient when compared to legacy methods (unicast paging).

Referring now to the drawings, and more particularly to FIGS. 2 through 14, where similar reference characters denote corresponding features consistently throughout the figures, there are shown at least one embodiment.

FIG. 1 illustrates the architecture (10) for the protocol stack for the UE implementation supporting MBS services. Mainly, three types of radio bearer architecture are shown, and are as follows:

1) PTP RLC bearer based (PTP MRB);

2) PTM RLC bearer based (PTM MRB); and

3) PTM+PTP RLC bearers based (MBS split bearer).

RLC PTM can be based unacknowledged mode (UM) RLC, which does not support functionality of automatic repeat request (ARQ) i.e., no RLC level transmission are supported as there is no feedback or status report between transmitting a sending RLC entity. Whereas RLC PTP can be either a UM mode or an acknowledged mode (AM) RLC. AM RLC supports status/feedback sharing from receiver to transmitter and retransmission of NACKed RLC packets from transmitter to receiver. Thereby, there is a further enhancement in the reliability that can be ensured with the AM RLC layer. Effectively, there is a lossless operation is achieved with utilizing the AM RLC mode.

PDCP layer performs reordering operation and employs a reordering timer t-Reordering to ensure the out of order packets received from RLC (from two RLCs in MBS split bearer) are re-arranged in order of their sequence numbers (SN) before expiry of reordering timer t-Reordering. In case reordering timer expires, and there is still a gap with PDCP receive window (i.e., missing a PDCP PDU SN so that reordering and in-sequence delivery could not be done to the higher layer), PDCP moves its own receive window (i.e., update its own state variable RX_DELIV) further and performs the delivery of PDCP PDUs received until window's lower edge, RX_DELIV (of course gap of missing PDCP PDU SN is also delivered).

Having an MBS split bearer with both PTM RLC and PTP RLC bearer adds to the reliability of the MBS bearer as lossless operation is achieved from the PTP path where a PTM path provides the packet with lesser delay as no retransmission is involved albeit with possible loss. With combining these two paths through the PDCP reordering operation, there is higher chances of receiving PDCP PDUs before t-Reordering expiry and providing ordered in-sequence delivery to the higher layer.

FIG. 2 illustrates an overview of a 5G communication network (300) for handling a service notification and configuration for the MBS according to embodiments as disclosed herein. In an embodiment, the 5G communication network (300) includes a UE (100) and a network entity (200). The UE (100) can be, for example, but not limited to a laptop, a desktop computer, a notebook, a relay device, a vehicle to everything (V2X) device, a smartphone, a tablet, an internet of things (IoT) device, an immersive device, a virtual reality device, a foldable device, a television with communication facility, a connected car, or the like. The network entity (200) may also include or be referred to by those skilled in the art as a base station, a base transceiver station, a radio base station, an access point, a radio transceiver, an eNB, a gNodeB (gNB), or the like.

In an embodiment, the UE (100) is configured to receive the MBS information through a SIB or a MCCH. The MBS information comprises the list of MBS services. Based on the received MBS information, the UE (100) is configured to indicate an available list of MBS services to a service layer of the UE (100) from a lower layer of the UE (100). The MBS information associated with each MBS service from the list of MBS services includes at least one field, wherein the at least one field comprises a TMGI of the MBS service, a session ID, a service type, a DRX configuration for the MBS service, MBS traffic channel (MTCH) configuration for the MBS service, neighbour cell information for the MBS service where for at least one neighbour cell same MBS service (as on serving cell) is one of available and not available, or a BWP over which MBS service, is being delivered.

The MCCH carries complete PTM configuration information and neighbor cell information for PTM service availability indication in at least one neighbor cell to support one of a cell re-selection and getting connected to avail service reception through unicast. The neighbor cell information includes a bitmap with a first value indicating at least one PTM service availability in the neighbor cell and a bitmap with a second value indicating at least one PTM service unavailability in the neighbor cell, where in the at least one PTM service is provided in the serving cell.

In an embodiment, the neighbor cell information is used to select a cell where the at least one PTM service, that the UE (100) is receiving or interested to receive, is indicated as available on the neighbor cell as the source cell. In another embodiment, the neighbor cell information is used to establish a RRC connection and avail MBS service through a unicast mode, upon handover to the neighbor cell where the at least one PTM service, that the UE (100) is receiving or interested to receive, is indicated as unavailable on the neighbor cell as the source cell. In an embodiment, the cell reselection is performed with prioritizing at least one frequency over which the MBS service is currently being provided on a source cell or on a frequency for a neighbor where MBS service is available.

In an embodiment, the at least one SIB is used for providing at least one of a MCCH configuration, a notification configuration or a control information, wherein the SIB is transmitted by at least one of a periodical SIB transmission, a SIB transmission only when there is change in the SIB, or an on-demand SIB acquisition when the UE (100) does not have stored SIB information and no page or a PDCCH change is indicated, wherein the at least one SIB is provided on a cell supporting MBS. In another embodiment, the at least one SIB is used for providing mapping of at least one of a MBS services, frequencies for reception and Service Area Identities (SAIs), wherein the at least one SIB is transmitted by at least one of a periodical SIB transmission, a SIB transmission only when there is change in the at least one SIB, or an on-demand SIB acquisition when the UE (100) does not have stored SIB information, wherein the at least one SIB is provided on a cell supporting MBS and not supporting MBS.

In another embodiment, the at least one SIB is used for also providing information for the frequencies which are supporting MBS and/or supporting multicast services and/or supporting specific service area identities (SAIs) pertaining to multicast services.

Based on the indication, the UE (100) is configured to synchronize an MBS service list in the USD with the available list of MBS services. Further, the UE (100) is configured to determine the available MBS service or the unavailable MBS service in the USD. Based on the determination, the UE (100) is configured to identify the interested MBS service from the available MBS service and trigger the service join procedure. Further, the UE (100) is configured to identify the interested MBS service from the unavailable MBS service and send the interest indication message to the network entity (200). The interest indication message includes information associated with the interested MBS service.

In another embodiment, the UE (100) is configured to receive the CN paging message from the network entity (200). The CN paging message includes the MBS paging list of a TMGIs for session activation. The UE (100) is in the RRC_IDLE state. Further, the UE (100) is configured to determine the activation for the non-activated session pertaining to the UE (100) based on the CN paging message. Further, the UE (100) is configured to perform the RRC connection establishment procedure between the UE (100) and the network entity (200).

Based on the RRC connection establishment procedure, the UE (100) is configured to send the session join request to the network entity (200). Further, the UE (100) is configured to receive the RRC reconfiguration message comprising an MBS service configuration from the network entity (200) for the activated MBS service based on the session join request. Based on the RRC reconfiguration message, the UE (100) is configured to receive the MBS data from the network entity (200).

In another embodiment, the UE (100) is configured to receive the RAN paging message from the network entity (200), where the RAN paging message comprises the MBS paging list of a TMGIs for session activation. The UE (100) is in the RRC_INACTIVE state. Based on the RAN paging message, the UE (100) is configured to determine the activation for the non-activated session pertaining to the UE (100).

Further, the UE (100) is configured to perform the RRC resume procedure between the UE (100) and the network entity (200). Further, the UE (100) is configured to receive the RRC reconfiguration message comprising an MBS service configuration from the network entity (200) for the activated MBS service. Based on the RRC reconfiguration message, the UE (100) is configured to receive the MBS data from the network entity (200).

In another embodiment, the UE (100) is in the RRC_CONNECTED state. The UE (100) receives the RRC reconfiguration message comprising an MBS service configuration from the network entity (200) for the activated MBS service. Further, the UE (100) determines the activation for the non-activated session pertaining to the UE (100) based on the RRC reconfiguration message. Further, the UE (100) receives the MBS data from the network entity (200) based on the RRC reconfiguration message.

In another embodiment, the network entity (200) is configured to receive one of a RRC resume request and a RRC connection request with at least one indication from the UE (100). The UE (100) is in one of an RRC_INACTIVE state and an RRC_IDLE state. The indication comprises the low priority MBS cause, the high priority MBS cause, the mt-access cause, and the critical MBS cause. Further, the network entity (200) is configured to accept one of the RRC resume request and the RRC connection request from the UE (100) if the at least one indication comprises a high priority MBS cause, the mt-access cause and the critical MBS cause. Further, the network entity (200) is configured to reject one of the RRC resume request and the RRC connection request from the UE (100) if the at least one indication comprises a low priority MBS cause, when the 5G communication network (300) is having congestion.

In an example, embodiments herein provide a mechanism for service notification and service configuration for multicast broadcast services for new radio (NR). In the NR, there can be possibly many different deployment scenarios e.g., A1, A2, B and B-Variant as detailed:
A. A1: the UE (100) can receive MBS service in an idle/inactive mode, however, in order to receive PTM configuration, the UE (100) needs to move to a connected mode and avail PTM configuration. Post that, the UE (100) can go back to the idle/inactive mode for the reception of MBS service;
B. A2: the UE (100) can receive MBS service in the connected mode only. The idle/inactive mode, the UE (100) may move to a connected mode to receive PTM configuration and stay in the connected mode for MBS service reception; and
C. B: the UE (100) can receive MBS service configuration in the idle/inactive mode and stay in the idle/inactive mode for MBS service reception.

Scenario: A2 (or A1): the UE (100) in idle/Inactive (as well as a connected mode) may be able to identify MBS service as multicast and broadcast so as to an initiate specific joining procedure (NAS) or a bearer configuration procedure (RRC).

Method 1: broadcasted MBS service list (for multicast and broadcast services OR only for broadcast services) (applicable for an idle, an inactive, and a connected mode UEs).

In an embodiment, overall available MBS services information is broadcasted and includes a list of MBS services with each having certain fields including at least one of TMGI of the MBS service, Session Id, Service type—whether broadcast or multicast, BWP over which MBS service is being delivered. The UEs (100) in a connected mode also avail this list of services to know availability over radio access network (RAN). In general, lower layer informs the available list of services (as received in broadcast i.e., RAN signaling) to the service layer, which can sync up with the service list in USD or program guide with the availability status. Unavailable MBS services, if desired, may add to interested MBS services (may also be considered in interest indication message). Whereas, available MBS services, if desired, may cause a service join procedure.
A. The UE (100) when determining availability of desired MBS service transits to a connected state and initiates a session join procedure.
B. MBS service configuration (PTM and/or PTP) received in a connected mode dedicated signaling pertains only to requested MBS service(s) by UE (100).

Some possible use cases for service type are as follows:
A. To transit to an idle/inactive state or not? (assuming solution A1 here and broadcast service being continued in an idle mode), and
B. To transit to a connected state or not? (assuming solution B here and broadcast service being received in an idle mode itself).

In an embodiment, with assuming solution A2 (or A1), limited information is broadcasted for MBS and rest configuration is availed in a connected mode dedicated signaling. System information block (SIB) provides this broadcast and MCCH is not required.

In an embodiment, SIB providing broadcast about MBS services information accessed on demand (i.e., SIB on demand, as and when the UE (100) requires to check present MBS service availability on the present cell). Any change for the SIB contents is determined by paging (change here implies addition/deletion of an MBS service). Alternatively, the broadcasted information is delivered by MCCH (MBS control channel).

In an embodiment, operational details for the UE (100) in different modes, after accessing the broadcasted information through SIB or MCCH, are as follows:
A. A UE (100) in the idle mode sets up RRC connection, by initiating a random access procedure and then avails MBS configuration information through RRC reconfiguration message and sets up MBS radio bearer which can be either PTM or PTP or MBS split bearer (i.e., consisting of both PTM and TP reception paths);
B. An inactive mode, the UE (100) initiates an RRC resume procedure to move to a connected state and avail MBS configuration and setup MBS service. Resume request message includes an indication for critical/multicast cause to avoid any rejection or congestion related issue. As when, the gNB notices the resume request message is carrying the critical/multicast MBS service setup cause, it does not reject the request and ensure the critical/multicast service is setup successfully for the UE (100). Critical service may pertain to public safety service like MCPTT (mission critical push-to-talk) etc.; and
C. A connected mode; the UE (100) proceeds with a session join procedure for MBS service and avails MBS PTM/PTP configuration and sets up MBS service.

For scenario A1, the UE (100) after availing the PTM configuration falls back to the idle/inactive mode and continue receiving the service. In an embodiment, the UE (100) determines the MBS service requirement whether the UE can be continued in the idle/inactive mode and accordingly, determines to fall back to the idle/inactive mode or continue in the connected mode. In some cases, it could be due to co-existence of other unicast services being received in the connected mode.

In an embodiment, a UE (100), which may or may not be able to support more than N (e.g., one, two or so on) G-RNTI at a time due to the implementation capability limitation, may indicate the same to the gNB through a RRC signaling message e.g., UE capability message. Based on the UE's capability and consequently, by network configuration, actual number of G-RNTIs supported for the UE (100) is determined. Accordingly, the PTM configuration to the UE (100) is provided for which the UE (100) is configured to use less or equal to N G-RNTIs at a time. In case the DRX scheduling configuration for the MBS services are disjoint, then potentially more than N G-GNTIs can also be configured. Alternatively, the gNB can multiplex more than one MBS services over a MAC PDU or transport block (TB) which is addressed by same G-RNTI. This way, a constrained UE can also support more services simultaneously.

An example MBS configuration parameters received in a connected mode is shown in table. 1.

TABLE 1

| CONFIGURATIONS | FILEDS | REMARKS |
|---|---|---|
| BEARER TYPE | PTM/PTP/SPLIT | |
| PTM | G-RNTI, | EITHER PTM OR PTP OR SPLIT |
| | TMGI, | BEARER WITH BOTH PTM & PTP |
| | SESSIONLD, | PTP TO FOLLOW PTM DRX |
| | ONDURAION TIME, | SCHEDULING OR UNICAST DRX |
| | DRX-INACTIVITY TIMER, | |
| | SCHEDULINGPELIOD, | |
| | STARTOFFSET | |
| PTP | G-RNTI, | |
| | TMGI, | |
| SDAP-CONFIG | PDU-SESSION, | SDAP-CONFIG AND |
| | MAPPEDQoS-FLOWSTOADD | PDCP-CONFIG DEPENDING ON THE |
| | MAPPEDQoS-FLOWSTORELEASE | COMMON PDCP OR DIFFERENT |
| PDCP-CONFIG | PDCP-SN-SIZEUL | PDCP OR DIFFERENT PDCP FOR |
| | PDCP-SN-SIZEDL | PTM AND PTP BEARERS, WILL BE |
| | HEADERCOMPRESSION, | COMMON OR SEPARATE |
| | STATUSREPORTREQUIRED, | T-REORDERING SHOULD BE |
| | OUTOFFORDERDELIVERY, | CONFIGURABLE BASED ON HARQ |
| | T-REORDERING, | MODES APPLICABLE |
| | CIPHERINGDISABLED | |
| RLC-CONFIG | PDCP-SN-SIZEUL | DL UM RLC FOR PTM |
| | PDCP-SN-SIZEDL | EITHER DL UM RLC OR AM RLC |
| | HEADERCOMPRESSION, | FOR PTP NOT |
| | STATUSREPORTREQUIRED, | |
| | OUTOFFORDERDELIVERY, | |
| | T-REORDERING | |
| MAC | LOGICAL CHANNEL CONFIG | |
| HARQ | HARQ MODES | |
| BWP | BWP INFORMATION | |

In one embodiment of Method 2, group paging approach (only for multicast services) (applicable for an idle mode UEs), a group paging or group notification is employed for the UEs (100) which transited to the idle mode but interested in multicast service. The group paging message includes the TMGI as paging identity. The UE (100) responds to the group paging with a session join procedure with TMGI and transits to a connected mode. The RAN sets up PTM/PTP/MBS-split bearer for the UE (100) as detailed in method 1. For inactive mode UEs, the RAN transits the inactive mode UEs to a connected state (when MBS session context is activated by AMF). The UE (100) receives the paging from RAN. A rest procedure can be same as that for the idle mode.

In an embodiment, following possible deployment approaches for scenario A2 (or A1) include:
A. Utilize method 1 for both multicast and broadcast; or
B. Utilize method 1 for broadcast only and method 2 for multicast.

Scenario: B (applicable for broadcast and/or multicast services in an idle/inactive modes).

In one embodiment of Method 3, utilizing MCCH channel for services information, an SIB is used for providing configuration of MCCH. PDCCH based notification for change of MCCH (change implies only new service start). MCCH carries complete PTM configuration information and neighbor cell information along with same PTM configuration indication in the neighbor cell(s) to support cell reselection. The neighbor cell information could be a bitmap with value 1 indicating same PTM configuration in neighbor cell and 0 indicating different PTM configuration information in the neighbor cell. Number of total bits can be N e.g., 8 bits to indicate 8 possible neighboring cells.

In an embodiment, considering large number of MBS service configurations, some standardized/default configuration are specified (e.g., certain SDAP/PDCP/RLC/MAC configuration options may be indexed). PTM configuration for MBS service can just carry the index to refer to standardized/default configurations where applicable. This way, it helps in processing and comparison/determination of any configuration change efficiently.

In an embodiment, a cell reselection is performed with prioritizing the frequency over which MBS services is currently being provided on the source cell or on the frequency for the neighbor where MBS service is available. Neighbor cell information is used to choose the cell where the PTM service configuration is same as the source cell so as the service continuity is maintained across cell reselection with minimum interruption time.

In one embodiment of Method 4, dedicated MBS SIB, an SIB is used for providing MBS service information and configuration. Paging and/or PDCCH based notification for SIB change is provided. SIB transmission in the provided approach is undertaken as per one of the different options as follows:
A. Option 1: Periodical SIB transmission to cater to large number of UEs in an idle mode;
B. Option 2: SIB transmission only when there is change in SIB; and
C. Option 3: On-demand SIB acquisition when the UE (100) does not have stored SIB information and no page/PDCCH change is indicated.

In an embodiment, only broadcast services and/or low reliability multicast services are provided in the idle/inactive mode for the UEs (100). For such MBS services, UM mode RLC and no HARQ or HARQ without a feedback mode is used.

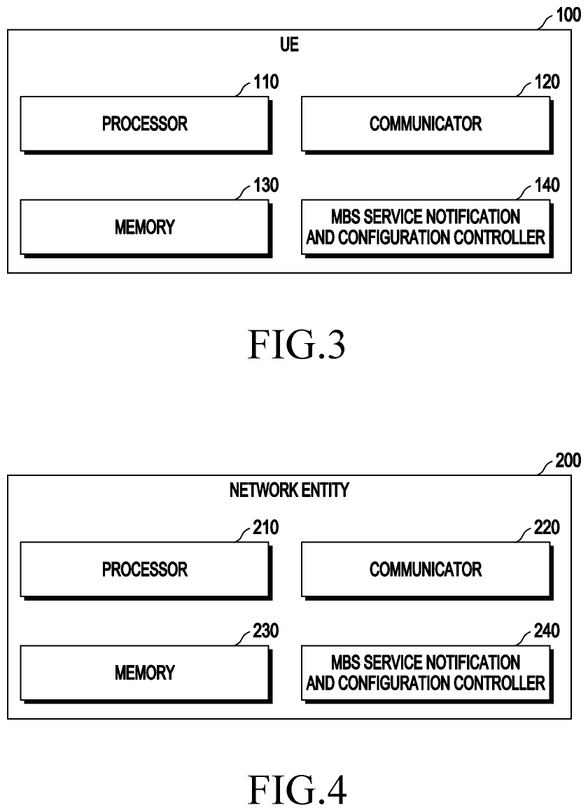

FIG. 3 illustrates various hardware components of the UE (100) according to embodiments as disclosed herein. The UE (100) includes a processor (110), a communicator (120), a memory (130) and an MBS service notification and configuration controller (140). The processor (110) is coupled with the communicator (120), the memory (130) and the MBS service notification and configuration controller (140).

In an embodiment, the MBS service notification and configuration controller (140) is configured to receive the MBS information through the SIB or the MCCH. The MBS information comprises the list of MBS services. Based on the received MBS information, the MBS service notification and configuration controller (140) is configured to indicate the available list of MBS services to the service layer of the UE (100) from the lower layer of the UE (100). Based on the indication, the MBS service notification and configuration controller (140) is configured to synchronize an MBS service list in the USD with the available list of MBS services. Further, the MBS service notification and configuration controller (140) is configured to determine the available MBS service or the unavailable MBS service in the USD.

Based on the determination, the MBS service notification and configuration controller (140) is configured to identify the interested MBS service from the available MBS service and trigger the service join procedure. Further, the MBS service notification and configuration controller (140) is configured to identify the interested MBS service from the unavailable MBS service and send the interest indication message to the network entity (200). The interest indication message includes information associated with the interested MBS service.

In another embodiment, the MBS service notification and configuration controller (140) is configured to receive the CN paging message from the network entity (200). The CN paging message includes the MBS paging list of a TMGIs for session activation. The UE (100) is in the RRC_IDLE state. Further, the MBS service notification and configuration controller (140) is configured to determine the activation for the non-activated session pertaining to the UE (100) based on the CN paging message. Further, the MBS service notification and configuration controller (140) is configured to perform the RRC connection establishment procedure between the UE (100) and the network entity (200).

Based on the RRC connection establishment procedure, the MBS service notification and configuration controller (140) is configured to send the session join request to the network entity (200). Further, the MBS service notification and configuration controller (140) is configured to receive the RRC reconfiguration message comprising an MBS service configuration from the network entity (200) for the activated MBS service based on the session join request. Based on the RRC reconfiguration message, the MBS service notification and configuration controller (140) is configured to receive the MBS data from the network entity (200).

In another embodiment, the MBS service notification and configuration controller (140) is configured to receive the RAN paging message from the network entity (200), where the RAN paging message comprises the MBS paging list of a TMGIs for session activation. The UE (100) is in the RRC_INACTIVE state. based on the RAN paging message, the MBS service notification and configuration controller (140) is configured to determine the activation for the non-activated session pertaining to the UE (100).

Further, the MBS service notification and configuration controller (140) is configured to perform the RRC resume procedure between the UE (100) and the network entity (200). Further, the MBS service notification and configuration controller (140) is configured to receive the RRC reconfiguration message comprising an MBS service configuration from the network entity (200) for the activated MBS service. based on the RRC reconfiguration message, the MBS service notification and configuration controller (140) is configured to receive the MBS data from the network entity (200).

The MBS service notification and configuration controller (140) is configured to receive the RRC reconfiguration message comprising an MBS service configuration from the network entity (200) for the activated MBS service, where the UE (100) is in the RRC_CONNECTED state. Further, the MBS service notification and configuration controller (140) is configured to determine an activation for at least one non-activated session pertaining to the UE (100) based on the RRC reconfiguration message. Further, the MBS service notification and configuration controller (140) is configured to receive the MBS data from the network entity (200) based on the RRC reconfiguration message.

The the MBS service notification and configuration controller (140) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in random access memory (RAM) or cache).

Further, at least one of the plurality of modules/controller may be implemented through the AI model. A function associated with the AI model may be performed through the non-volatile memory, the volatile memory, and the processor (110). The processor (110) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although the FIG. 3 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the disclosure. One or more components can be combined together to perform same or substantially similar function in the UE (100).

FIG. 4 shows various hardware components of the network entity (200) according to embodiments as disclosed herein. The network entity (200) includes a processor (210), a communicator (220), a memory (230) and an MBS service notification and configuration controller (240). The processor (210) is coupled with the communicator (220), the memory (230) and the MBS service notification and configuration controller (240).

In an embodiment, the MBS service notification and configuration controller (240) is configured to send the CN paging message to the UE (100). The CN paging message includes the MBS paging list of the TMGIs for session activation and the UE (100) is in the RRC_IDLE state. Further, the MBS service notification and configuration controller (240) is configured to perform the RRC connection establishment procedure between the UE (100) and the network entity (200) in response to determining the activation for at least one non-activated session pertaining to the UE (100) based on the CN paging message. Based on the RRC connection establishment procedure, the MBS service notification and configuration controller (240) is configured to receive the session join request from the UE (100).

Further, the MBS service notification and configuration controller (240) is configured to send the RRC reconfiguration message comprising the MBS service configuration to the UE (100) for the activated MBS service based on the session join request. Based on the RRC reconfiguration message, the MBS service notification and configuration controller (240) is configured to send the MBS data to the UE (100).

In another embodiment, the MBS service notification and configuration controller (240) is configured to send the RAN paging message to the UE (100). The RAN paging message includes the MBS paging list of the TMGIs for session activation and the UE (100) is in the RRC_INACTIVE state. Further, the MBS service notification and configuration controller (240) is configured to perform the RRC resume procedure between the UE (100) and the network entity (200) in response to determining the activation for at least one non-activated session pertaining to the UE (100) based on the RAN paging message.

Further, the MBS service notification and configuration controller (240) is configured to send the RRC reconfiguration message comprising the MBS service configuration to the UE (100) for the activated MBS service. Based on the RRC reconfiguration message, the MBS service notification and configuration controller (240) is configured to send the MBS data to the UE (100).

The MBS service notification and configuration controller (240) is configured to send the RRC reconfiguration message comprising the MBS service configuration to the UE (100) for the activated MBS service, where the UE (100) is in the RRC_CONNECTED state. Further, the MBS service notification and configuration controller (240) is configured to send the MBS data to the UE (100) based on the RRC reconfiguration message upon determining an activation for the non-activated session pertaining to the UE (100) based on the RRC reconfiguration message.

In another embodiment, the MBS service notification and configuration controller (240) is configured to receive one of a RRC resume request and a RRC connection request with at least one indication from the UE (100). The UE (100) is in one of an RRC_INACTIVE state and an RRC_IDLE state. The indication comprises the low priority MBS cause, the high priority MBS cause, the mt-access cause, and the critical MBS cause. Further, the MBS service notification and configuration controller (240) is configured to accept one of the RRC resume request and the RRC connection request from the UE (100) if the at least one indication comprises a high priority MBS cause, the mt-access cause and the critical MBS cause. Further, the MBS service notification and configuration controller (240) is configured to reject one of the RRC resume request and the RRC connection request from the UE (100) if the at least one indication comprises a low priority MBS cause, when the 5G communication network (300) is having congestion.

The MBS service notification and configuration controller (240) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in random access memory (RAM) or cache).

Further, at least one of the plurality of modules/controller may be implemented through the AI model. A function associated with the AI model may be performed through the non-volatile memory, the volatile memory, and the processor (210). The processor (210) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although the FIG. 4 shows various hardware components of the network entity (200) but it is to be understood that other embodiments are not limited thereon. In other embodiments, the network entity (200) may include less or more number of components. Further, the labels or names of the components are used only for illustrative purpose and does not limit the scope of the disclosure. One or more components can be combined together to perform same or substantially similar function in the network entity (200).

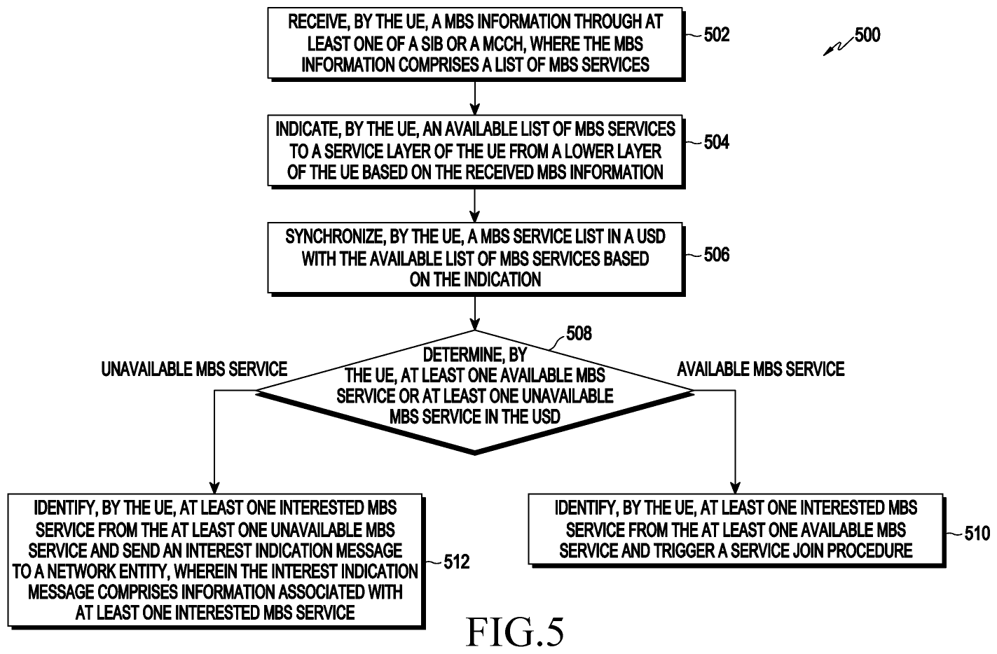

FIG. 5 is a flow chart (500) illustrating a method, implemented by the UE (100), for handling the service notification and configuration for the MBS in the 5G communication network (300) based on the MBS information according to embodiments as disclosed herein. The operations (502-512) are handled by the MBS service notification and configuration controller (140).

At 502, the method includes receiving the MBS information through the SIB or the MCCH. The MBS information comprises a list of MBS services. At 504, the method includes indicating the available list of MBS services to a service layer of the UE (100) from a lower layer of the UE (100) based on the received MBS information. At 506, the method includes synchronizing an MBS service list in the USD with the available list of MBS services based on the indication. At 508, the method includes determining the available MBS service or the unavailable MBS service in the USD.

At 510, the method includes identifying an interested MBS service from the available MBS service and triggering a service join procedure. At 512, the method includes identifying the interested MBS service from the unavailable MBS service and sending an interest indication message to the network entity (200). The interest indication message includes information associated with the interested MBS service.

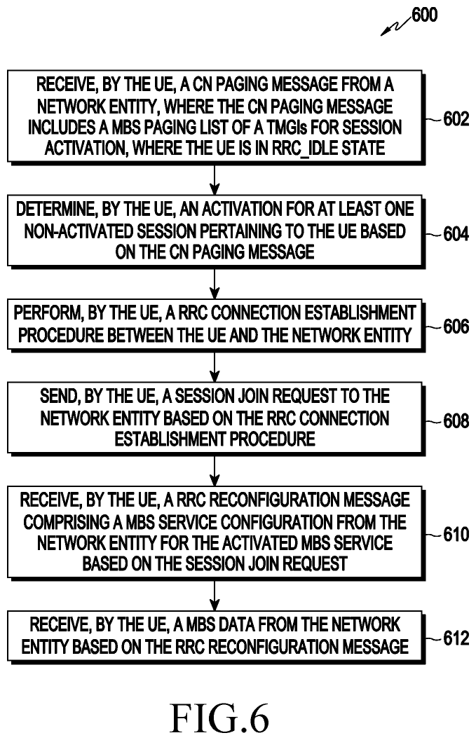

FIG. 6 is a flow chart (600) illustrating a method, implemented by the UE (100), for handling the service notification and configuration for the MBS in the 5G communication network (300) based on the CN paging message according to embodiments as disclosed herein. The operations (602-612) are handled by the MBS service notification and configuration controller (140).

At 602, the method includes receiving the CN paging message from the network entity (200). The CN paging message includes the MBS paging list of a TMGIs for session activation. The UE (100) is in the RRC_IDLE state. At 604, the method includes determining the activation for the non-activated session pertaining to the UE (100) based on the CN paging message. At 606, the method includes performing the RRC connection establishment procedure between the UE (100) and the network entity (200).

At 608, the method includes sending the session join request to the network entity (200) based on the RRC connection establishment procedure. At 610, the method includes receiving the RRC reconfiguration message comprising an MBS service configuration from the network entity (200) for the activated MBS service based on the session join request. At 612, the method includes receiving the MBS data from the network entity (200) based on the RRC reconfiguration message.

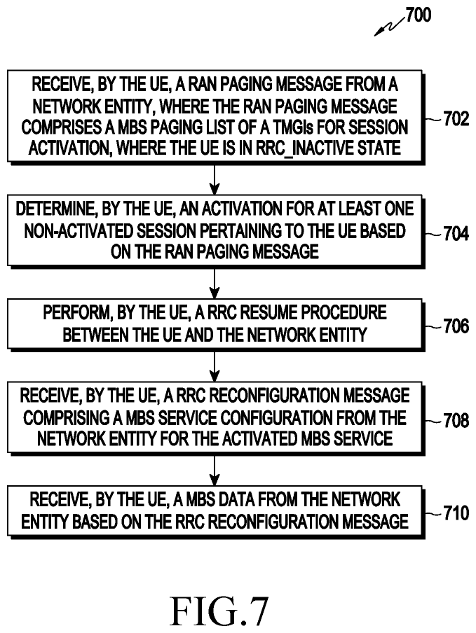

FIG. 7 is a flow chart (700) illustrating a method, implemented by the UE (100), for handling the service notification and configuration for the MBS in the 5G communication network (300) based on the RAN paging message according to embodiments as disclosed herein. The operations (702-710) are handled by the MBS service notification and configuration controller (140).

At 702, the method includes receiving the RAN paging message from the network entity (200), where the RAN paging message comprises an MBS paging list of a TMGIs for session activation. The UE (100) is in an RRC_INACTIVE state. At 704, the method includes determining the activation for the non-activated session pertaining to the UE (100) based on the RAN paging message.

At 706, the method includes performing the RRC resume procedure between the UE (100) and the network entity (200). At 708, the method includes receiving the RRC reconfiguration message comprising an MBS service configuration from the network entity (200) for the activated MBS service. At 710, the method includes receiving an MBS data from the network entity (200) based on the RRC reconfiguration message.

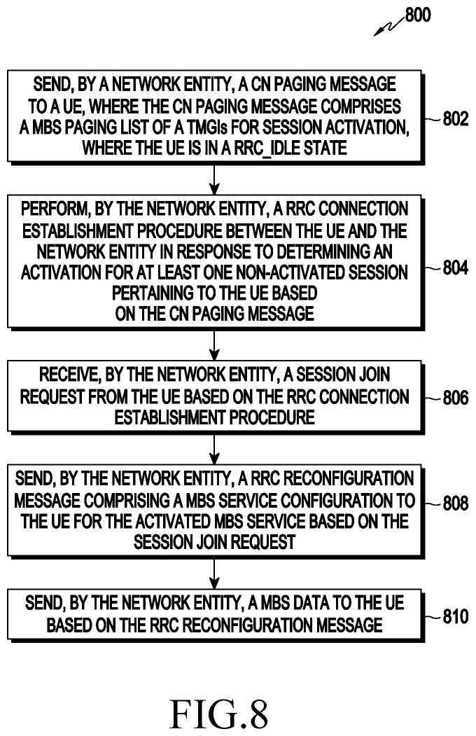

FIG. 8 is a flow chart (800) illustrating a method, implemented by the network (200), for handling the service notification and configuration for the MBS in the 5G communication network (300) based on the CN paging message according to embodiments as disclosed herein. The operations (802-810) are handled by the MBS service notification and configuration controller (240).

At 802, the method includes sending the CN paging message to the UE (100). The CN paging message includes an MBS paging list of a TMGIs for session activation and the UE (100) is in an RRC_IDLE state. At 804, the method includes performing the RRC connection establishment procedure between the UE (100) and the network entity (200) in response to determining an activation for at least one non-activated session pertaining to the UE (100) based on the CN paging message. At 806, the method includes receiving the session join request from the UE (100) based on the RRC connection establishment procedure.

At 808, the method includes sending the RRC reconfiguration message comprising an MBS service configuration to the UE (100) for the activated MBS service based on the session join request. At 810, the method includes sending an MBS data to the UE (100) based on the RRC reconfiguration message.

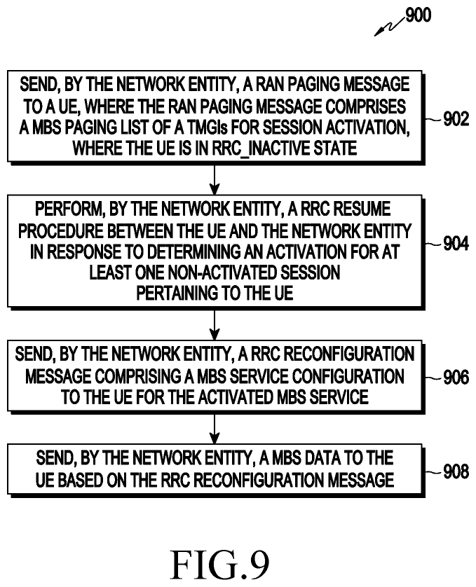

FIG. 9 is a flow chart (900) illustrating a method, implemented by the network (200), for handling the service notification and configuration for the MBS in the 5G communication network (300) based on the RAN paging message according to embodiments as disclosed herein. The operations (902-908) are handled by the MBS service notification and configuration controller (240).

At 902, the method includes sending the RAN paging message to the UE (100). The RAN paging message includes an MBS paging list of a TMGIs for session activation and the UE (100) is in an RRC_INACTIVE state. At 904, the method includes performing the RRC resume procedure between the UE (100) and the network entity (200) in response to determining the activation for at least one non-activated session pertaining to the UE (100) based on the RAN paging message.

At 906, the method includes sending the RRC reconfiguration message comprising the MBS service configuration to the UE (100) for the activated MBS service. At 908, the method includes sending the MBS data to the UE (100) based on the RRC reconfiguration message.

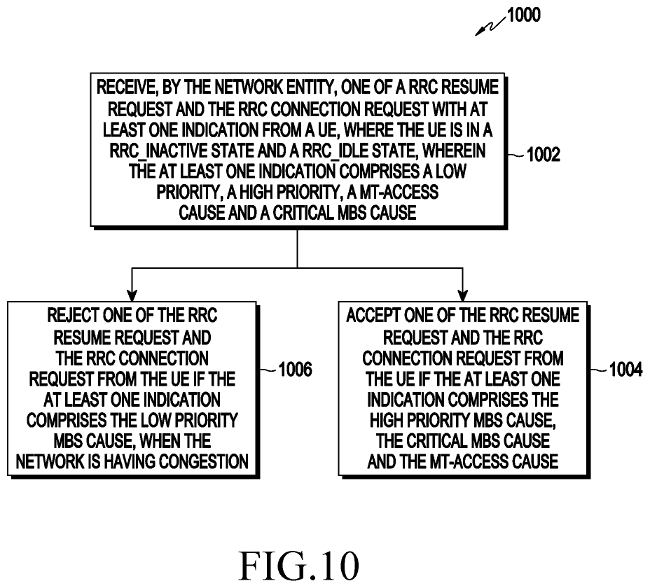

FIG. 10 is a flow chart (1000) illustrating a method, implemented by the network (200), for handling the service notification and configuration for the MBS in the 5G communication network (300) according to embodiments as disclosed herein. The operations (902-906) are handled by the MBS service notification and configuration controller (240).

At 1002, the method includes receiving one of a RRC resume request and a RRC connection request with at least one indication from the UE (100). The UE (100) is in one of an RRC_INACTIVE state and an RRC_IDLE state. The indication comprises a low priority MBS cause, a high priority MBS cause, a mt-access cause, a critical MBS cause. At 1004, the method includes accepting one of the RRC resume request and the RRC connection request from the UE (100) if the at least one indication comprises a high priority MBS cause, the mt-access cause and the critical MBS cause. At 1006, the method includes rejecting one of the RRC resume request and the RRC connection request from the UE (100) if the at least one indication comprises a low priority MBS cause, when the 5G communication network (300) is having congestion

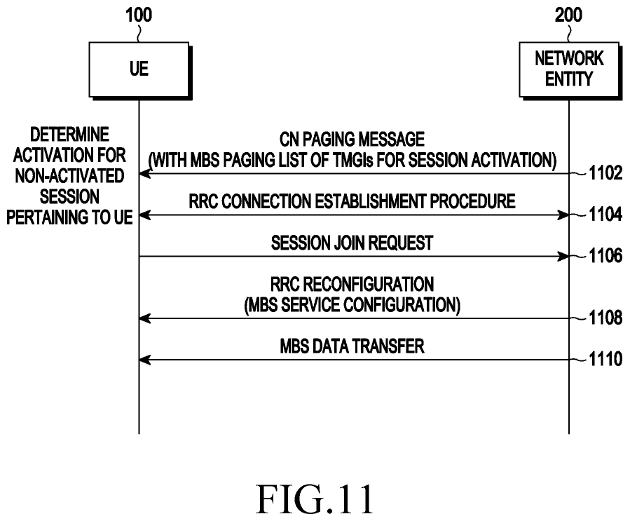

FIG. 11 is a sequence flow diagram illustrating step by step operations for handling the service notification and configuration for the MBS in the 5G communication network (300) based on the CN paging message according to embodiments as disclosed herein.

At 1102, the UE (100) receives the CN paging message from the network entity (200). The CN paging message includes the MBS paging list of the TMGIs for session activation. The UE (100) is in the RRC_IDLE state. Further, the UE (100) determines the activation for the non-activated session pertaining to the UE (100) based on the CN paging message. At 1104, the RRC connection establishment procedure is performed between the UE (100) and the network entity (200).

At 1106, the UE (100) sends the session join request to the network entity (200) based on the RRC connection establishment procedure. At 1108, the UE (100) receives the RRC reconfiguration message comprising the MBS service configuration from the network entity (200) for the activated MBS service based on the session join request. At 1110, the UE (100) receives the MBS data from the network entity (200) based on the RRC reconfiguration message.

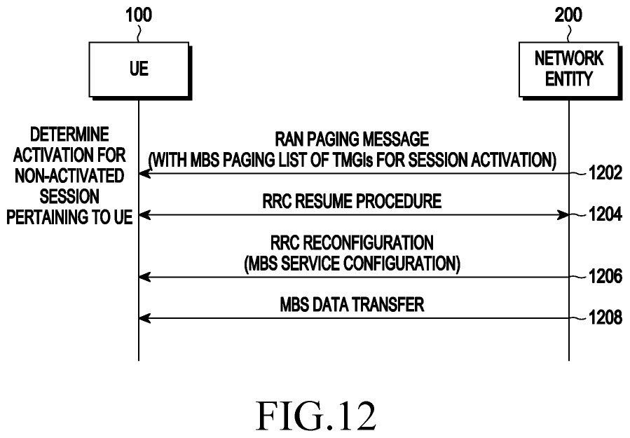

FIG. 12 is a sequence flow diagram illustrating step by step operations for handling the service notification and configuration for the MBS in the 5G communication network (300) based on the RAN paging message according to embodiments as disclosed herein.

At 1202, the UE (100) receives the RAN paging message from the network entity (200), where the RAN paging message comprises an MBS paging list of the TMGIs for session activation. The UE (100) is in the RRC_INACTIVE state. Further, the UE (100) determines the activation for the non-activated session pertaining to the UE (100) based on the RAN paging message.

At 1204, the RRC resume procedure is performed between the UE (100) and the network entity (200). At 1206, the UE (100) receives the RRC reconfiguration message comprising the MBS service configuration from the network entity (200) for the activated MBS service. At 1208, the UE (100) receives the MBS data from the network entity (200) based on the RRC reconfiguration message.

The method can be used to enable a reliable delivery of MBS services by introducing split radio bearer (i.e., PTP+PTM). The method can be used for group notifications for UEs in an idle/inactive state about MBS services which is more efficient when compared to legacy methods (unicast paging).

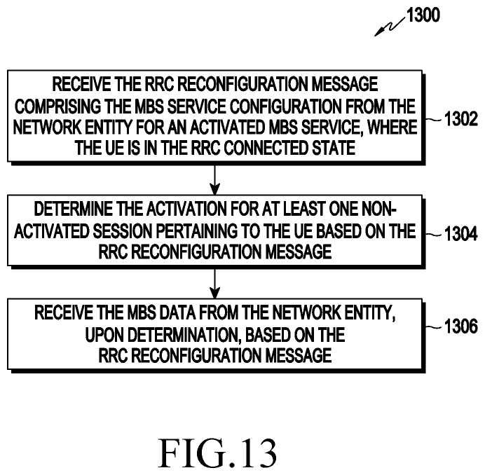

FIG. 13 is a flow chart (1300) illustrating a method, implemented by the UE (100), for handling a service notification and configuration for the MBS in the 5G communication network (300), when the UE (100) is in the RRC CONNECTED state. according to embodiments as disclosed herein. The operations (1302-1306) are handled by the MBS service notification and configuration controller (140).

At 1302, the method includes receiving the RRC reconfiguration message comprising the MBS service configuration from the network entity (200) for an activated MBS service. The UE (100) is in the RRC CONNECTED state. At 1304, the method includes determining the activation for at least one non-activated session pertaining to the UE (100) based on the RRC reconfiguration message. At 1306, the method includes receiving the MBS data from the network entity (200), upon determination, based on the RRC reconfiguration message.

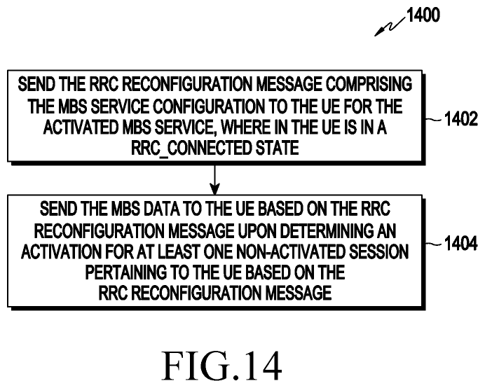

FIG. 14 is a flow chart (1400) illustrating a method, implemented by the network entity (200), for handling the service notification and configuration for the MBS in the 5G communication network (300), when the UE (100) is in the RRC CONNECTED state according to embodiments as disclosed herein. The operations (1402 and 1404) are handled by the MBS service notification and configuration controller (240).

At 1402, the method includes sending the RRC reconfiguration message comprising the MBS service configuration to the UE (100) for the activated MBS service, wherein the UE (100) is in an RRC_CONNECTED state. At 1404, the method includes sending the MBS data to the UE (100) based on the RRC reconfiguration message upon determining an activation for at least one non-activated session pertaining to the UE (100) based on the RRC reconfiguration message.

The various actions, acts, blocks, steps, or the like in the flow charts (500-1000, 1300 and 1400) may be performed in the order presented, in a different order or simultaneously. Further, in some embodiments, some of the actions, acts, blocks, steps, or the like may be omitted, added, modified, skipped, or the like without departing from the scope of the disclosure.

The embodiments disclosed herein can be implemented through at least one software program running on at least one hardware device and performing network management functions to control the elements. The elements can be at least one of a hardware device, or a combination of hardware device and software module.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication network, the method comprising:
receiving multicast broadcast service (MBS) configuration information via at least one a system information block (SIB) or a multicast control channel (MCCH),
wherein the MBS configuration information includes complete point-to-multipoint (PTM) configuration information and neighbor cell information for PTM service availability in at least one neighbor cell to support cell reselection.

2. The method of claim 1, further comprising:
indicating an available list of an MBS to a service layer of the UE from a lower layer of the UE based on the received MBS configuration information;
synchronizing an MBS list in a user service description (USD) with the available list of the MBS based on an indication that the available list of the MBS to the service layer of the UE from the lower layer of the UE;
determining at least one of at least one available MBS or at least one unavailable MBS from the synchronized MBS list in the USD; and
performing at least one of:
identifying at least one interested MBS from the at least one unavailable MBS and sending an interest indication message to a network entity, wherein the interest indication message comprises information associated with the at least one interested MBS, or
identifying the at least one interested MBS from the at least one available MBS and triggering a service join procedure.

3. The method of claim 1, wherein the MBS configuration information associated with each MBS from a list of MBS comprises at least one field, wherein the at least one field comprises a TMGI of the MBS, a session identifier (ID), a service type, a discontinuous reception (DRX) configuration for the MBS, an MBS traffic channel (MTCH) configuration for the MBS, neighbour cell information for the MBS where for at least one neighbour cell same MBS is one of available and not available, or a bandwidth part (BWP) over which MBS, is being delivered.

4. The method of claim 1, wherein the neighbor cell information is used to select a cell, for an idle mode mobility or an inactive mode mobility, where at least one PTM service that the UE is receiving or interested to receive is indicated as available on the at least one neighbor cell as a source cell.

5. The method as claimed in claim 1, further comprising:
transmitting, to a network entity, message indicating UE capability,
wherein a radio network temporary identifier (RNTI) supported for the UE is determined based on the UE capability.

6. The method of claim 1, wherein the cell reselection is performed with prioritizing at least one frequency over which an MBS is currently being provided on a source cell or on a frequency for a neighbor cell where the MBS is available.

7. The method of claim 1, wherein the SIB is used for providing at least one of a MCCH configuration, a notification configuration, or control information, wherein the SIB is transmitted by at least one of a periodical SIB transmission, an SIB transmission only when there is change in the SIB, or an on-demand SIB acquisition when the UE does not store SIB information and no page or a physical downlink control channel (PDCCH) change is indicated, and wherein the SIB is provided on a cell supporting the MBS.

8. The method of claim 1, wherein the SIB is used for providing mapping of at least one of an MBS, frequencies for reception and service area identities (SAIs), wherein the SIB is transmitted by at least one of a periodical SIB transmission, an SIB transmission only when there is change in the SIB, or an on-demand SIB acquisition when the UE does not store SIB information, and wherein the SIB is provided on a cell one of supporting MBS and not supporting the MBS.

9. The method of claim 1, further comprising:
sending one of a radio resource control (RRC) resume request or an RRC connection request with at least one indication to a network entity, wherein the UE is in one of an RRC_inactive state or an RRC_idle state, and wherein the at least one indication comprises a low priority MBS cause, a high priority MBS cause, a critical MBS cause, an MBS cause, and an mt-access cause; and
receiving a response corresponding to one of the RRC resume request or the RRC connection request from the network entity based on the at least one indication. DOCKET NO.: SAMS05-26413 PATENT

10. A method performed by a user equipment (UE) in a wireless communication network, the method comprising:
receiving a core network (CN) paging message from a network entity, the CN paging message including a multicast broadcast service (MBS) paging list of a temporary mobile group identities (TMGIs) for session activation, and the UE being in a radio resource control (RRC) idle state;
determining activation for at least one non-activated session pertaining to the UE based on the CN paging message;
performing an RRC connection establishment procedure with the network entity;
transmitting a session join request to the network entity;
receiving an RRC reconfiguration message comprising an MBS configuration from the network entity for an activated MBS based on the session join request; and
receiving MBS data from the network entity based on the RRC reconfiguration message. DOCKET NO.: SAMS05-26413 PATENT

11. A user equipment (UE) in a wireless communication network, the UE comprising:
a communicator;
a processor;
memory; and
an MBS service notification and configuration controller, operably coupled with the communicator, the processor and the memory, configured to:
receive multicast broadcast service (MBS) configuration information via a system information block (SIB) or a multicast control channel (MCCH), wherein the MBS configuration information includes complete point-to-multipoint (PTM) configuration information and neighbor cell information for PTM service availability in at least one neighbor cell to support a cell reselection.

12. The UE of claim 11, wherein the MBS service notification and configuration controller is further configured to:
indicate an available list of an MBS to a service layer of the UE from a lower layer of the UE based on the received MBS configuration information;
synchronize an MBS list in a user service description (USD) with the available list of the MBS based on the indication that the available list of the MBS to the service layer of the UE from the lower layer of the UE;
determine at least one of at least one available MBS or at least one unavailable MBS from the synchronized MBS list in the USD;
perform at least one of:
identifying at least one interested MBS from the at least one unavailable MBS and send an interest indication message to a network entity, wherein the interest indication message comprises information associated with the at least one interested MBS; or identifying the at least one interested MBS from the at least one available MBS and triggering a service join procedure.

13. The UE of claim 11, wherein the MBS configuration information comprises at least one field, wherein the at least one field comprises a temporary mobile group identifier (TMGI) of the MBS, a session identifier (ID), a service type, a discontinuous reception (DRX) configuration DOCKET NO.: SAMS05-26413 PATENT for the MBS, an MBS traffic channel (MTCH) configuration for the MBS, neighbour cell information for the MBS where, for at least one neighbour cell, a same MBS is one of available and not available, or a bandwidth part (BWP) over which MBS, is being delivered.

14. The UE of claim 11, wherein the neighbor cell information is used to select a cell, for an idle mode mobility or an inactive mode mobility, where at least one PTM service that the UE is receiving or interested to receive is indicated as available on the at least one neighbor cell as a source cell.

15. The UE of claim 11, wherein the MBS service notification and configuration controller is further configured to transmit, to a network entity, message indicating UE capability, wherein a radio network temporary identifier (RNTI) supported for the UE is determined based on the UE capability.

16. The UE of claim 11, wherein the cell reselection is performed with prioritizing at least one frequency over which an MBS is currently being provided on a source cell or on a frequency for a neighbor cell where MBS is available.

17. The UE of claim 11, wherein the SIB is used for providing at least one of a MCCH configuration, a notification configuration, or control information, wherein the SIB is transmitted by at least one of a periodical SIB transmission, an SIB transmission only when there is change in the SIB, or an on-demand SIB acquisition when the UE does not store SIB information and no page or a physical downlink control channel (PDCCH) change is indicated, and wherein the SIB is provided on a cell supporting the MBS.

18. The UE of claim 11, wherein the SIB is used for providing mapping of at least one of a MBS service, frequencies for reception and service area identities (SAIs), wherein the SIB is transmitted by at least one of a periodical SIB transmission, an SIB transmission only when there is change in the SIB, or an on-demand SIB acquisition when the UE does not store SIB information, and wherein the SIB is provided on a cell supporting MBS and not supporting the MBS. DOCKET NO.: SAMS05-26413 PATENT

19. The UE of claim 11, wherein the MBS service notification and configuration controller is further configured to:
send one of a radio resource control (RRC) resume request or an RRC connection request with at least one indication to a network entity, wherein the UE is in one of an RRC inactive state or an RRC idle state, and wherein the at least one indication comprises a low priority MBS cause, a high priority MBS cause, a critical MBS cause, an MBS cause, and an mt-access cause; and
receive a response corresponding to the RRC resume request or the RRC connection request from the network entity based on the at least one indication. DOCKET NO.: SAMS05-26413 PATENT

20. A user equipment (UE) in a wireless communication network, the UE comprising:
a communicator;
a processor, memory, and an MBS service notification and configuration controller, operably coupled with the communicator, the processor and the memory, configured to:
receive, from a network entity, a core network (CN) paging message including a multicast broadcast service (MBS) paging list of a temporary mobile group identities (TMGIs) for a session activation, and the UE being in a radio resource control (RRC) idle state;
determine an activation for at least one non-activated session pertaining to the UE based on the CN paging message;
perform an RRC connection establishment procedure with the network entity;
transmit a session join request to the network entity;
receive an RRC reconfiguration message comprising an MBS configuration from the network entity for an activated MBS based on the session join request; and
receive MBS data from the network entity based on the RRC reconfiguration message.
